(19) United States
(12) Patent Application Publication
(10) Pub. No.: US 2006/0036968 A1
(43) Pub. Date: Feb. 16, 2006

(54) Confirming a processing action

(76) Inventors: Aurobinda Pradhan, Bangalore (IN); Uma Kant Singh, Bangalore (IN); Ajit Kumar Narayanan, Bangalore (IN)

Correspondence Address: FISH & RICHARDSON, P.C., PO BOX 1022, MINNEAPOLIS, MN, 55440-1022, US

(21) Appl. No.: 10/915,996

(22) Filed: Aug. 11, 2004

(51) Int. Cl. G06F 17/00

(52) U.S. Cl. 715/800; 715/823

(57) ABSTRACT

Confirming a performed processing action to a computer user may comprise performing, in a computer system, a processing action for which a visual confirmation is made to a user. The computer system may include a display device having a work area wherein an application program output is being displayed. Upon performing the processing action, a portion of the application program output that is displayed in a part of the work area may cease to be displayed, and the visual confirmation may be displayed in the part of the work area. Upon receiving a user input while displaying the visual confirmation, the visual confirmation ceases to be displayed in the part of the work area and the portion of the application program output is displayed in the part of the work area. The visual confirmation may cover or displace the application program output while it is being displayed.

### TECHNICAL FIELD

This description relates to confirming a performed processing action to a computer user.

### BACKGROUND

There are many processing actions performed in computer systems that are not apparent to users. Some of these actions are user-prompted, such as saving an updated document or deleting a file. Other actions may be performed at predefined times without specific user interaction.

The user may, however, wish to have some confirmation that a processing action has been performed. First, a confirmation assures the user that the computer is working properly. Second, when the processing action is user-prompted, the confirmation assures the user that he or she made the intended input. That is, a confirmation that says “Data Successfully Saved” or equivalent indicates that the user clicked the “Save” button as opposed to another button.

Status bars can be used to confirm processing actions. For example, a status bar may be continuously displayed in a user interface, for example at the top or bottom of the screen. When a processing action is performed, the status bar may display a confirmation message to the user. One disadvantage with permanent status bars is that they take up screen space also when they are not needed. This can be a problem, particularly in a handheld computer device where the screens are usually smaller, because the status bar occupies valuable space that is needed for other content.

Another existing approach is popup windows that may appear on a screen to display a message to the user, for example to confirm a processing action. However, because popup windows appear “on top of” other content, it may be necessary to create them with a certain size to make them distinguishable from other content. Accordingly, a popup window may occupy more screen space than what is necessary to convey its message. Moreover, popup windows may have a generic appearance that is different from the look and feel of the application program that the user is currently working with. Finally, popup windows may be modal, which means they remain open until the user takes a predefined action, such as clicking a specific button, to close them.

### SUMMARY

The invention relates to confirming a processing action.

In a first general aspect, a method of confirming a performed processing action to a computer user comprises performing, in a computer system, a processing action for which a visual confirmation is made to a user. The computer system includes a display device having a work area wherein an application program output is being displayed. Upon performing the processing action, the method comprises ceasing to display a portion of the application program output that is displayed in a part of the work area, and displaying the visual confirmation in the part of the work area. Upon receiving a user input while displaying the visual confirmation, the method comprises ceasing to display the visual confirmation in the part of the work area and displaying the portion of the application program output in the part of the work area.

In some embodiments, the application program output is displaced in the work area so as to not be displayed in the part of the work area, while the visual confirmation is being displayed in the part of the work area. In other embodiments, the application program output is not displaced in the work area while the visual confirmation is being displayed in the part of the work area.

The visual confirmation may further include a user-selectable input control for enlarging the visual confirmation to a greater part of the work area. If the visual confirmation includes a confirmation message that fits within the visual confirmation when written in a first language and that does not fit when written in a second language, the user-selectable input control may be provided when the confirmation message is to be written in the second language.

In a second general aspect, a graphical user interface that confirms a performed processing action to a user comprises a work area wherein an application program output is displayed, and a visual confirmation of a performed processing action. The visual confirmation is temporarily displayed in a part of the work area, wherein a portion of the application program output that is displayed in the part of the work area ceases to be displayed in the part of the work area while the visual confirmation is being temporarily displayed.

Advantages of the systems and techniques described herein may include any or all of the following. Providing an improved confirmation of a performed processing action. Providing a visual confirmation that requires little screen space. Providing a more efficient graphical user interface. Providing a visual confirmation with increased flexibility for displaying a confirmation message written in different languages.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1A-1D show a computer system with a graphical user interface;

FIG. 2 shows a flow chart of an embodiment of an inventive method; and

FIG. 3 is a block diagram of a general computer system.

Like reference numerals in the various drawings indicate like elements.

### DETAILED DESCRIPTION

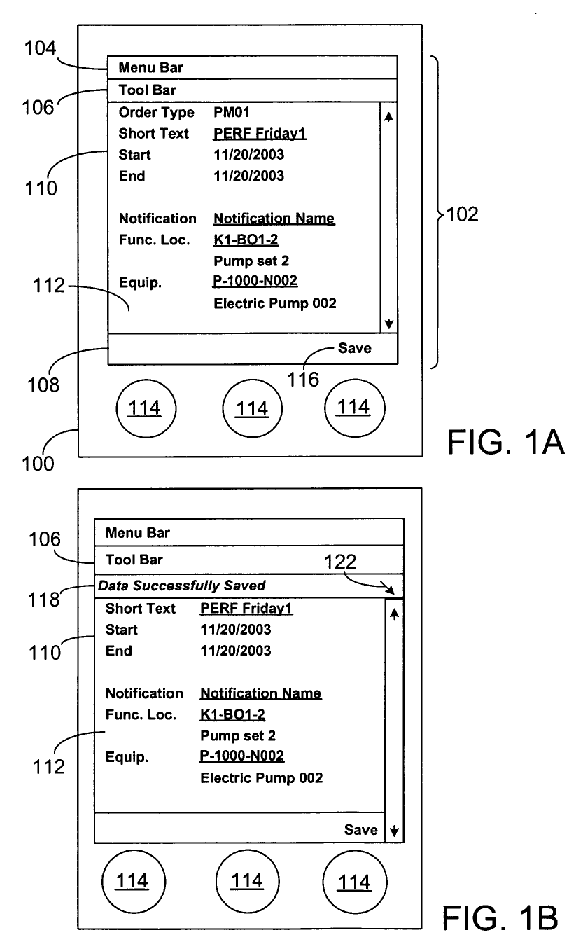

FIGS. 1A-1D show a computer system 100 in various stages of operation. In this embodiment, the system 100 is a handheld computer device. A sales management application program is currently being executed in the system 100. For example, the system 100 may download data or programs while being connected to a main computer system (online mode), and the user may thereafter work with the downloaded materials also when the connection is interrupted (offline mode).

The system 100 includes a display device 102 that provides a visible screen for the handheld device. The display device currently includes a menu bar 104, a tool bar 106, an input command bar 108 and a work area 110. For example, the menu bar 104 may include user-selectable commands provided by an operating system of the system 100, and the tool bar 106 and the input command bar 108 may include commands provided by the particular application program. In this example, the work area 110 is currently displaying an application program output 112 that includes information such as “Order Type,” “Short Text” and so on. The user can make inputs in the system using any or all of physical buttons 114. In some implementations, the display device 102 includes a touch-sensitive screen by which the user can make inputs, for example using a stylus.

Here, the user has made a change in the information of the output 112 and wants to save the change in the system 100. The user therefore selects a “Save” button 116 in the input command bar 108. The system receives the save request that the user inputs, and saves the information in response to the request. The save operation involves a processing action, such as updating a memory in the system.

The processing action is one that is visually confirmed to the user. The system may therefore display, as shown in FIG. 1B, a visual confirmation 118 in a part of the work area 110. The visual confirmation states “Data Successfully Saved”. In this example, the visual confirmation 118 is displayed toward the top of the work area, immediately below the tool bar 106. A portion of the output 112 ceases to be displayed in the part of the work area. Here, that portion includes the information “Order Type”, which is currently not displayed. Accordingly, in some implementations the displayed visual confirmation may be considered to “cover” a portion of the application program output.

In other implementations, the displayed visual confirmation may be considered to “displace” the application program output. An example of this is shown in FIG. 1C, where the visual confirmation 118 is displayed immediately below the tool bar 106 like in the previous example. Here, a portion of the application program output 112 ceases to be displayed in the part of the work area where the visual confirmation is being displayed. The application program output, including the portion, is displaced in the work area 110. Accordingly, and in contrast to the previously discussed implementation, the portion of the output that includes the “Order Type” information is displayed immediately below the visual confirmation. The displacement may cause another portion of the application program output to extend beyond the work area 110. For example, the information “Electric Pump 002” which is visible in FIGS. 1A and 1B, is not visible in FIG. 1C because it does not currently fit within the work area 110. The user can scroll the output 112 using a scrolling function 120.

Referring now to FIGS. 1B and 1C, the visual confirmation 118 ceases to be displayed in the part of the work area upon the system receiving a user input. For example, the user can make an input with any of the buttons 114 or by selecting a command on a touch-sensitive screen. Other examples include the user input being made with a keyboard or a mouse connected to the system 100. The user is not required to click a particular “close” button or equivalent for the confirmation to disappear. In other words, the user may simply continue with the next operation that the user intended to perform, without worrying about acknowledging or closing the visual confirmation. Sometimes, the user may not even be aware that it is the user's input that makes the confirmation disappear. After the system ceases to display the confirmation, the display device 102 may appear essentially as shown in FIG. 1A.

In some implementations, a message contained in the visual confirmation 118 may be too large to be displayed in its entirety. Moreover, it may be desirable to not automatically enlarge the visual confirmation to fit any size message because this consumes screen space that may be needed for the application program output. For longer messages, then, the visual confirmation may include a user-selectable input control 122, here an arrow, by which the user can enlarge the visual confirmation.

Selecting the input control 122 may cause the display device to appear as shown in FIG. 1D. The visual confirmation 118 now occupies a greater part of the work area 110. Accordingly, less of the application program output 112 is currently visible. While no text of the output 112 currently is visible, a portion of the scrolling mechanism 120 can be seen. In the visual confirmation, on the other hand, there is displayed more information than in FIGS. 1B or 1C. Particularly, the visual confirmation currently displays log information organized by three arbitrary logs: Log-1, Log-2 and Log-3. The visual confirmation 118 may include its own scrolling mechanism 124.

While the enlarged visual confirmation is being displayed, a greater portion of the application program output 112 ceases to be displayed in that area. Similarly to the description of the visual confirmation 118 in FIGS. 1B and 1C, the enlarged visual confirmation in FIG. 1D may “cover” or “displace” the greater portion of the application program output. For example, while the visual confirmation is being displayed in the greater part of the work area, the application program output may be displaced in the work area so as to not be displayed in the greater part of the work area, yet may be displayed elsewhere in the work area if there is enough space. As another example, a greater portion of the application program output may cease to be displayed in the greater part of the work area and not be displayed elsewhere in the work area.

Providing the input control 122 may be valuable in implementations where the system 100 is to be used in different countries. Particularly, system output messages, such as the confirmation message in the visual confirmation 118, may be translated into a different language depending on the country where the system is to be used. Moreover, the confirmation message written in a first language may fit in the visual confirmation 118 without enlargement, but the confirmation message written in a second language may not. This situation may occur when only the first-language version of the message is taken into account when the visual confirmation 118 is designed, perhaps because no translations exist at design time. Accordingly, providing the visual confirmation 118 with the control 122 and the ability to be enlarged may provide an increased flexibility for displaying a confirmation message written in different languages.

The user can reverse the enlargement of the visual confirmation by selecting an input control 126. Clicking on the control 126 may bring the display device back to its appearance shown in FIG. 1B or 1C, respectively, depending on its state when the user clicked the control 122. The control 126 does not cause the system to cease displaying the visual confirmation 118. This is in contrast to another user input that makes the visual confirmation disappear. That is, the user may choose to clear the visual confirmation in its entirety by making an input with any of the buttons 114, clicking in the work area 110, or using one of the bars 104, 106 or 108. Alternatively, the user may revert the visual confirmation to its previous (smaller) size using the control 126.

In selected embodiments, the visual confirmation may include one selected from the group consisting of a message, a symbol, an image, status information, and combinations thereof. That is, the confirmation may include a message together with a status symbol, for example.

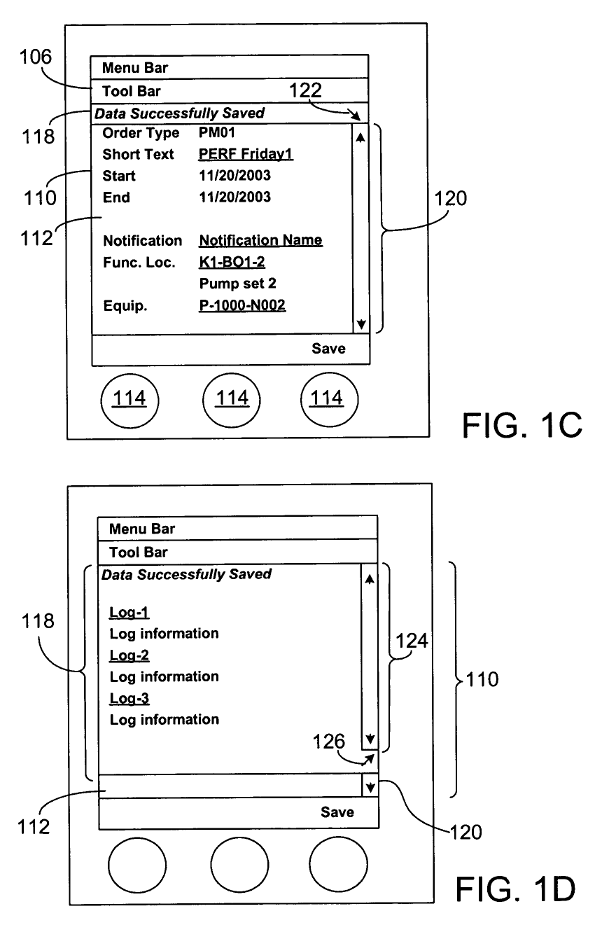

FIG. 2 includes a flow chart of a method 200 that is an embodiment of an inventive method. The method 200 may be performed in the system 100. For example, a computer program product may include instructions that cause a processor to perform operations comprising the steps of method 200. As shown in FIG. 2, the method 200 includes the following steps:

Performing, in step 210 and in a computer system, a processing action for which a visual confirmation is made to a user, the computer system including a display device having a work area wherein an application program output is being displayed. For example, the system 100 may, optionally in response to a user request, perform a save operation regarding contents of the application program output 112.

Upon performing the processing action, ceasing, in step 220 to display a portion of the application program output that is displayed in a part of the work area, and displaying the visual confirmation in the part of the work area. For example, the system 100 may display the visual confirmation 118 in a part of the work area 110 upon performing the save operation. The system 100 may cease to display a portion of the application program output 112 that is displayed in the part of the work area. The portion of the application program output 112 that ceases to be displayed may be “covered” by the visual confirmation or may be displaced in the work area 110.

Upon receiving a user input while displaying the visual confirmation, ceasing, in step 230, to display the visual confirmation in the part of the work area and displaying the portion of the application program output in the part of the work area. For example, the system 100 can cease to display the visual confirmation 118 upon a user input made with any of the buttons 114 or with a touch-sensitive screen on the display device 102. As another example, the enlarged state of the visual confirmation 118 may cease to be displayed upon receiving a similar user input. That is, the user may activate the control 122 to cause the visual confirmation to be enlarged, and may thereafter cause the visual confirmation to disappear by clicking elsewhere on the display device 102. If, on the other hand, the user activates the control 126 while the enlarged visual confirmation is being displayed, the confirmation may return to its previous size, and thereafter disappear upon receipt of another user input.

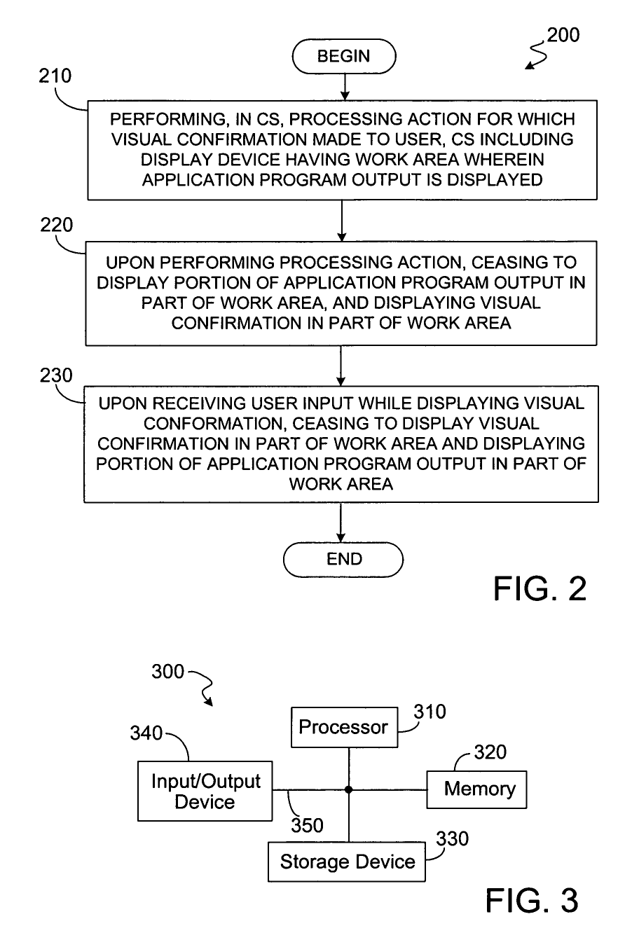

FIG. 3 is a block diagram of a computer system 300 that can be used in the operations described above, according to one embodiment. For example, the system 300 may constitute all or part of the system 100.

The system 300 includes a processor 310, a memory 320, a storage device 330 and an input/output device 340. Each of the components 310, 320, 330 and 340 are interconnected using a system bus 350. The processor 310 is capable of processing instructions for execution within the system 300. In one embodiment, the processor 310 is a single-threaded processor. In another embodiment, the processor 310 is a multi-threaded processor. The processor 310 is capable of processing instructions stored in the memory 320 or on the storage device 330 to display graphical information for a user interface on the input/output device 340. Particularly, the processor 310 can perform a processing action for which a visual confirmation is made to a user.

The memory 320 stores information within the system 300. In one embodiment, the memory 320 is a computer-readable medium. In one embodiment, the memory 320 is a volatile memory unit. In another embodiment, the memory 320 is a non-volatile memory unit.

The storage device 330 is capable of providing mass storage for the system 300. In one embodiment, the storage device 330 is a computer-readable medium. In various different embodiments, the storage device 330 may be a floppy disk device, a hard disk device, an optical disk device, or a tape device.

The input/output device 340 provides input/output operations for the system 300. In one embodiment, the input/output device 340 includes a keyboard and/or pointing device. In one embodiment, the input/output device 340 includes a display device for displaying graphical user interfaces. Particularly, the input/output device 340 can constitute all or part of the display device 102.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, the visual confirmation 118 can be displayed in any part of the work area 110. Accordingly, other embodiments are within the scope of the following claims.

What is claimed is:

1. A method of confirming a performed processing action to a computer user, the method comprising:
performing, in a computer system, a processing action for which a visual confirmation is made to a user, the computer system including a display device having a work area wherein an application program output is being displayed;
upon performing the processing action, ceasing to display a portion of the application program output that is displayed in a part of the work area, and displaying the visual confirmation in the part of the work area; and
upon receiving a user input while displaying the visual confirmation, ceasing to display the visual confirmation in the part of the work area and displaying the portion of the application program output in the part of the work area.

2. The method of claim 1, wherein, while the visual confirmation is being displayed in the part of the work area, the application program output is displaced in the work area so as to not be displayed in the part of the work area.

3. The method of claim 1, wherein the application program output is not displaced in the work area while the visual confirmation is being displayed in the part of the work area.

4. The method of claim 1, wherein the visual confirmation further includes a user-selectable input control for enlarging the visual confirmation to a greater part of the work area.

5. The method of claim 4, wherein the visual confirmation includes a confirmation message, and wherein the confirmation message fits within the visual confirmation when written in a first language and does not fit within the visual confirmation when written in a second language, wherein the visual confirmation is provided with the user-selectable input control when the confirmation message is to be written in the second language.

6. The method of claim 4, wherein, while the visual confirmation is being displayed in the greater part of the work area, the application program output is displaced in the work area so as to not be displayed in the greater part of the work area.

7. The method of claim 4, wherein the application program output is not displaced in the work area while the visual confirmation is being displayed in the greater part of the work area.

8. The method of claim 4, wherein the user selects an input control to revert the visual confirmation to the part of the work area.

9. The method of claim 1, wherein the processing action is performed upon receiving a request input by the user.

10. The method of claim 1, wherein the visual confirmation is one selected from the group consisting of: a message, a symbol, an image, status information, and combinations thereof.

11. The method of claim 1, wherein the user input is made using one selected from the group consisting of: a physical button, a mouse, a key, a touch-sensitive screen on the display device, and combinations thereof.

12. The method of claim 1, wherein the computer system comprises a handheld computer device.

13. A computer program product tangibly embodied in an information carrier, the computer program product including instructions that, when executed, cause a processor to perform operations comprising.
perform, in a computer system, a processing action for which a visual confirmation is made to a user, the computer system including a display device having a work area wherein an application program output is being displayed;
upon performing the processing action, cease to display a portion of the application program output that is displayed in a part of the work area, and display the visual confirmation in the part of the work area; and
upon receiving a user input while displaying the visual confirmation, cease to display the visual confirmation in the part of the work area and display the portion of the application program output in the part of the work area.

14. The computer program product of claim 13, wherein the operations further comprise:
displace the application program output in the work area while the visual confirmation is being displayed in the part of the work area, so that the application program output is not displayed in the part of the work area.

15. The computer program product of claim 13, wherein the operations further comprise:
display the visual confirmation in the part of the work area without displacing the application program output in the work area.

16. A computer program product tangibly embodied in an information carrier, the computer program product including instructions that, when executed, generate on a display device a graphical user interface that confirms a performed processing action to a user, the graphical user interface comprising:
a work area wherein an application program output is displayed; and
a visual confirmation of a performed processing action, the visual confirmation being temporarily displayed in a part of the work area, wherein a portion of the application program output that is displayed in the part of the work area ceases to be displayed in the part of the work area while the visual confirmation is being temporarily displayed.

17. The computer program product of claim 16, wherein, while the visual confirmation is being temporarily displayed in the part of the work area, the application program output is displaced in the work area so as to not be displayed in the part of the work area.

18. The computer program product of claim 16, wherein the application program output is not displaced in the work area while the visual confirmation is being displayed in the part of the work area.

19. The computer program product of claim 16, wherein the visual confirmation further includes a user-selectable input control for enlarging the visual confirmation to a greater part of the work area.

20. The computer program product of claim 19, wherein, while the visual confirmation is being displayed in the greater part of the work area, the application program output is displaced in the work area so as to not be displayed in the greater part of the work area.

21. The computer program product of claim 19, wherein the application program output is not displaced in the work area while the visual confirmation is being displayed in the greater part of the work area.
